(19) United States
(12) Patent Application Publication
(10) Pub. No.: US 2020/0370947 A1
(43) Pub. Date: Nov. 26, 2020

(54) DEVICES AND METHODS FOR VIBRATION ANALYSIS

(71) Applicant: Fraunhofer-Gesellschaft zur Forderung der angewandten Forschung e.V, Munchen (DE)

(72) Inventor: Peter HUSAR, Ilmenau (DE)

(21) Appl. No.: 16/989,982

(22) Filed: Aug. 11, 2020

Related U.S. Application Data
(63) Continuation of application No. PCT/EP2019/053979, filed on Feb. 18, 2019.

(30) Foreign Application Priority Data
Feb. 20, 2018 (DE) 102018202559.2

(51) Int. Cl. G01H 9/00

(52) U.S. Cl. CPC G01H 9/00

(57) ABSTRACT

A device for vibration analysis includes capturing means and evaluating means. The capturing means is configured to capture a pattern from a surface to be measured to provide a captured image of the pattern. The evaluating means is configured to evaluate the captured image in order to obtain, by comparing the captured image with a reference image, an evaluation result including information regarding vibration of the surface to be measured.

### CROSS-REFERENCE TO RELATED APPLICATIONS

This application is a continuation of co-pending International Application No. PCT/EP2019/053979, filed Feb. 18, 2019, which is incorporated herein by reference in its entirety, and additionally claims priority from German Application No. DE 102018202559.2, filed Feb. 20, 2018, which is incorporated herein by reference in its entirety.

The present invention relates to devices for vibration analysis of a surface to be measured, to methods for vibration analysis and to a computer program. The present invention further relates to an arrangement and method for pattern-based optical vibration analysis of rotating machines.

### BACKGROUND OF THE INVENTION

Previous diagnostics for condition monitoring of machines and detection of defects is based on capturing structure-borne sound of the rotating parts themselves and/or on capturing vibrations of the machine body, such as a cover, fastenings or the buildup, and on corresponding evaluation.

The vibrations are usually picked up directly or contactlessly from the surface of the machine by means of mechanoelectrical transducers such as piezo transducers, or optical transducers such as photodiodes or cameras. In some cases, lasers are also used for contactless capturing of structure-borne sound, for example in a laser microphone, a laser Doppler or a laser interferometer. Especially for contactless vibration analysis, which in many areas of machine application is the only alternative to vibration measurement because aggressive gases, liquids, a radioactive environment and/or other hazardous applications are involved, almost exclusively optical (visual, infrared and/or ultraviolet), partly radiating (such as radar or microwaves) sources or methods may possibly be used. Since the distances to be measured are within the range of micrometers and/or since speeds may occur that lie within the range of millimeters per second and/or accelerations may occur that lie within the range of meters/s², which are in the lower range of measuring sensitivity, direct measurement is hardly possible. Thus, secondary measurement quantities are used by means of optical methods, for example laser interferometry or laser Doppler, in order to be able to capture such low measurement values at all. The need for an extremely sensitive measuring technique results from a realistic comparison: a gas turbine may reach dimensions of up to 10 m. The cover or its body will vibrate within a range of a few micrometers. For optical measurement capturing, this means that the desired measurement quantity (vibration deflection) is smaller than the basic equipment by a factor of 10⁷. Under such conditions, direct measurement technology is not possible within any range; auxiliary quantities such as Doppler frequencies or a number of interference fringes may therefore be used.

The functional principle of optical arrangements and methods used so far have been known for along time and have been sufficiently proven. However, they are also very complex and therefore cost-intensive. Under these conditions, mass use is not realistic, even permanent control of the machine condition is hardly justifiable—at best, cyclical but discontinuous monitoring is carried out.

Therefore, a concept for simple contactless vibration analysis of components would be desirable.

### SUMMARY

According to an embodiment, a device for vibration analysis may have: capturing means including an image sensor and configured to capture a pattern from a surface to be measured to provide a captured image of the pattern; evaluation means configured to evaluate the captured image in order to obtain, by comparing the captured image with a reference image, information on a displacement of the surface to be measured between the image captured and the reference image, and to obtain an evaluation result including information regarding vibration of the surface to be measured; wherein the pattern is a two-dimensional pattern including a multitude of stripes or concentric rings arranged side by side, the multitude of stripes or rings having a multitude of brightness intensities; wherein the multitude of brightness intensities are arranged within the two-dimensional pattern in an aperiodic order; or wherein the multitude of brightness intensities are arranged within the two-dimensional pattern in accordance with a sin function.

According to another embodiment, a vibration analysis method may have the steps of: capturing a pattern from a surface to be measured; providing a captured image of the pattern; evaluating the captured image and obtaining an evaluation result by comparing the captured image with a reference image so that the evaluation result includes information regarding vibration of the surface to be measured; so that the pattern is a two-dimensional pattern including a multitude of stripes or concentric rings arranged side by side, and the multitude of stripes or rings include a multitude of brightness intensities; so that the multitude of brightness intensities are arranged within the two-dimensional pattern in an aperiodic order; or so that the multitude of brightness intensities are arranged within the two-dimensional pattern in accordance with a sinc function.

According to yet another embodiment, a non-transitory digital storage medium may have a computer program stored thereon to perform the inventive method, when said computer program is run by a computer.

According to one embodiment, a device for vibration analysis comprises capturing means configured to capture a pattern from a surface to be measured in order to provide a captured image of the pattern. The device further comprises evaluation means configured to evaluate the captured image to obtain by comparing the captured image with a reference image, an evaluation result which comprises information regarding vibration of the surface to be measured. This is advantageous in that, on the basis of the comparison of the captured image with the reference image, only the changes in the image are used for obtaining the information about the vibration, which enables fast and robust evaluation. At the same time, simple sensors, such as image sensors, may be used to capture the image.

According to one embodiment, the evaluation means is configured to perform the comparison on the basis of a cross-correlation between the captured image and the reference image. This is advantageous in that the cross-correlation allows a mathematically simple comparison between the image and the reference image, so that little computing power is sufficient to obtain the information regarding the vibration.

According to one embodiment, the capturing means is configured to capture a multitude of images of the pattern in a multitude of iterations and to provide a multitude of images. The image is a second image of the multitude of images that is captured in a second iteration, the reference image is a first image of the multitude of images that is captured in a preceding first iteration. The evaluation means is configured to compare the first image with the second image to obtain first information about a displacement (shift) of the surface to be measured between the first image and the second image, and to compare the second image with a third image, captured in a third iteration following the second iteration, to obtain second information about the displacement of the surface to be measured between the second image and the third image. The information on the vibration includes the first information on the displacement and the second information on the displacement. This is advantageous in that for each iteration of captured images, displacement information of the surface to be measured may be obtained sequentially within the iteration, which may be aggregated in the information concerning the vibration. This means that by aggregating several items of displacement information over time, information about the vibration may be obtained.

According to one embodiment, the evaluation means is configured to have a correlator configured to perform a cross-correlation between the image and the reference image and to provide a correlation result. The evaluation means further comprises a peak detector configured to determine a maximum value of the cross-correlation. The evaluation means comprises a signal processor configured to determine, on the basis of the maximum value, a vibration distance which at least partially forms the information concerning the vibration. The maximum value of the correlation may provide information concerning a displacement of the surface to be measured within a time period between the capturing of the reference image and the capturing of the image. By evaluating the offset of the maximum value on an axis which correlates with the time axis, it is thus possible to determine the vibration distance, which may be converted into different values of the information via further temporal consideration, for example by double integration of distance toward the dimension of time toward the dimension of acceleration.

According to one embodiment, the capturing means is configured to comprise an image sensor, the evaluation means being configured to provide the evaluation result on the basis of an evaluation of a displacement of the pattern on the image sensor. This is advantageous in that a displacement on the image sensor may be captured with little computational effort and, thus, the information regarding the vibration may be provided with little computational effort, so that both high measuring frequencies may be used and/or low-power computing components may be used.

According to an embodiment, the pattern within a plane of the image sensor is designed, by projection along a first sensor direction and along a second sensor direction of the image sensor, in such a way that the pattern has an extension which is larger than that of the image sensor, which means that the pattern may cover the image sensor over a large area or even completely. This is advantageous in that one may assume, with a high degree of certainty, that the pattern is projected onto the image sensor and that corresponding detection steps for recognizing a location of the pattern may be dispensed with, so that the device may operate at a high repetition rate.

According to one embodiment, the pattern is a two-dimensional pattern comprising a multitude of stripes or concentric rings arranged side by side. The multitude of stripes or rings have at least first and second brightness intensities. This is advantageous in that the two-dimensional pattern may cover a large area of the surface to be measured at least in the measuring area and that, at the same time, simple evaluation of a displacement of the pattern may be determined.

According to one embodiment, the multitude of stripes or rings comprise a multitude of brightness intensities. This is advantageous in that the measuring accuracy is high.

According to one embodiment, the multitude of brightness intensities are arranged within the two-dimensional pattern in an aperiodic order. The advantage is that robust evaluation of the displacement of the image with respect to the reference image is possible because on the basis of the aperiodic order. e.g. by using a sinc function, arbitrary displacements between the images may be captured, and periodicities within the image, which might affect evaluation, are avoided.

According to one embodiment, the device is configured to measure the surface to be measured in a curved area thereof. This is advantageous in that direct measurement results may also be obtained for rotating parts and that a loss of accuracy due to capturing of indirect components is avoided. This may be achieved in a particularly advantageous combination by using the two-dimensional pattern, which avoids, for example, that a dot pattern based on the curved surface will be scattered too much, which would lead to poor measurement results.

According to one embodiment, the device comprises an optical signal source configured to emit the pattern towards the surface to be measured. Although, according to alternative examples, the pattern may also be applied directly to the surface to be measured, for example by means of a sticker or by means of a printing process, the optical signal source makes it possible to measure any surface without preparing the surface to be measured or changing it.

According to one embodiment, a transmitting direction along which the optical signal source is configured to transmit the pattern, and a receiving direction from which the capturing means is configured to receive the pattern are arranged perpendicularly to each other within a tolerance range of ±15°. It is advantageous that high curvatures in the surface to be measured lead to negligible impairment of the reflection of the pattern and that, therefore, surfaces to be measured which exhibit large curvatures may also be measured.

According to one embodiment, the capturing means is configured to capture a multitude of images of the pattern with a frequency of at least 40 kHz, the evaluation means being configured to provide the evaluation result in such a way that it contains information about vibrations exhibiting a frequency of at least 20 kHz. What is advantageous about this is that one may capture vibrations of the surface to be measured or in the surface to be measured which are within the acoustic range.

According to one embodiment, the evaluation means is configured to provide the information regarding the vibration of the surface to be measured in such a way that the information comprises an indication of a power spectrum of the vibration of the surface to be measured (18) and/or of an order spectrum of the vibration of the surface to be measured (16) and/or of a change in a spectrum over time and/or a change in location of the spectrum and/or an extrapolation of a vibration value and/or a comparison result of the vibration or of a value derived therefrom with a threshold value. This is advantageous in that a vibration analysis with a high degree of subdivision is made possible by appropriate preprocessing.

According to one embodiment, a device for vibration analysis comprises capturing means configured to capture a two-dimensional pattern, such as a two-dimensional pattern formed according to the previously described embodiments, from a surface to be measured to provide a captured image of the two-dimensional pattern. The device comprises an evaluation means configured to evaluate the image of the two-dimensional pattern to obtain an evaluation result comprising information regarding vibration of the surface to be measured. This is advantageous in that by using a two-dimensional pattern, extremely robust evaluation may be obtained even if the surface to be measured is curved, as is the case with ball bearings, for example.

According to one embodiment, the evaluation means is configured to obtain the evaluation result by comparing the captured image with a reference image, which evaluation result contains the information regarding the vibration of the surface to be measured. This is advantageous in that the robust result may be obtained with a low computational effort.

According to one embodiment, a vibration analysis method comprises capturing a pattern from a surface to be measured. The method further comprises providing a captured image of the pattern. The method comprises evaluating the captured image and obtaining an evaluation result by comparing the captured image with a reference image so that the evaluation result comprises information regarding vibration of the surface to be measured.

According to one embodiment, a vibration analysis method comprises capturing a two-dimensional pattern of a surface to be measured, providing a captured image of the two-dimensional pattern, and evaluating the image of the two-dimensional pattern, and obtaining an evaluation result comprising information regarding vibration of the surface to be measured.

Further embodiments refer to a computer program for performing the described methods.

### BRIEF DESCRIPTION OF THE DRAWINGS

Embodiments of the present invention will be detailed subsequently referring to the appended drawings, in which:

FIG. 1 shows a schematic block diagram of a device for vibration analysis according to an embodiment;

FIG. 2a shows a schematic graph for explaining the mode of operation of an evaluation means according to one embodiment:

FIG. 2b shows a schematic diagram of a graph in which the one curve is converted into discrete values according to an embodiment on the basis of being scanned by using a capturing means:

FIG. 2c shows a schematic representation of a graph in which a comparison between respectively successive images has been carried out according to an embodiment;

FIG. 3 shows a schematic block diagram of a vibration measuring device according to a further embodiment;

FIG. 4a shows a schematic diagram of a comparison between two captured patterns on an image sensor according to an embodiment;

FIG. 4b shows a schematic representation of an evaluation result according to an embodiment;

FIG. 4c shows a schematic simplified representation of a central region of the graph of FIG. 4b according to an embodiment;

FIG. 4d shows a schematic representation of a functional relationship between the vibration of a surface to be measured and a projection of a pattern as well as capturing by the camera according to an embodiment;

FIG. 5 shows a schematic block diagram of a device for vibration analysis according to a further embodiment, the device comprising an image memory;

FIG. 6a shows a schematic view of a striped pattern according to an embodiment;

FIG. 6b shows a schematic perspective view of an image sensor on which the pattern of FIG. 6a;

FIG. 6c shows a schematic representation of an intensity distribution of a striped pattern according to a further embodiment in which individual stripes may have different intensities:

FIG. 6d shows a schematic perspective view of the striped pattern of FIG. 6c;

FIG. 6e shows a schematic top view of the striped pattern of FIG. 6c, in which the multitude of brightness intensities along an image direction become clear;

FIG. 6f shows a schematic top view of a ring pattern according to an embodiment;

FIG. 6g shows a schematic perspective view of an intensity distribution of a ring pattern according to an embodiment in which the intensities of the individual rings are arranged according to the sinc function; and

FIG. 6h shows a schematic top view of a projection of the ring pattern of FIG. 6g onto a flat surface.

### DETAILED DESCRIPTION OF THE INVENTION

Before the following embodiments of the present invention will be explained in detail on the basis of the drawings, it shall be pointed out that identical elements, objects and/or structures having the same function or effect are provided with the same reference numerals in the different figures, so that the descriptions of these elements that are provided in the different embodiments are interchangeable or mutually applicable.

Some of the embodiments described below refer to one-dimensional or two-dimensional patterns. In connection with the embodiments described herein, a one-dimensional pattern is understood to be a pattern that has at least one but also a larger number of points arranged, for example, along a line, and in particular along a straight line. Although the use of a single point may also be understood as a zero-dimensional pattern, it is considered to be a one-dimensional pattern for the sake of simplicity. However, a two-dimensional pattern is a pattern that has a relevant extension along two directions on a surface to be measured and/or on a captured image sensor. This includes, for example, striped patterns which have at least one, but advantageously a plurality and particularly advantageously a multitude of stripes arranged next to one other. Each of the stripes extends along a first pattern direction or image direction. The number of stripes may be arranged side by side along the second, possibly vertically arranged, direction, so that the stripes together form the two-dimensional pattern. Without limiting this teaching, other patterns extending along two directions are also considered to be two-dimensional patterns. For example, a pattern comprising at least one polygon at least one ellipse, in particular a circle or a number of at least two, advantageously a higher number, of concentric ellipses or circles with different radii or diameters. Here, adjacent rings may have different brightness intensities, so that starting from a common inner region or center point, different brightness intensities are passed through along any direction.

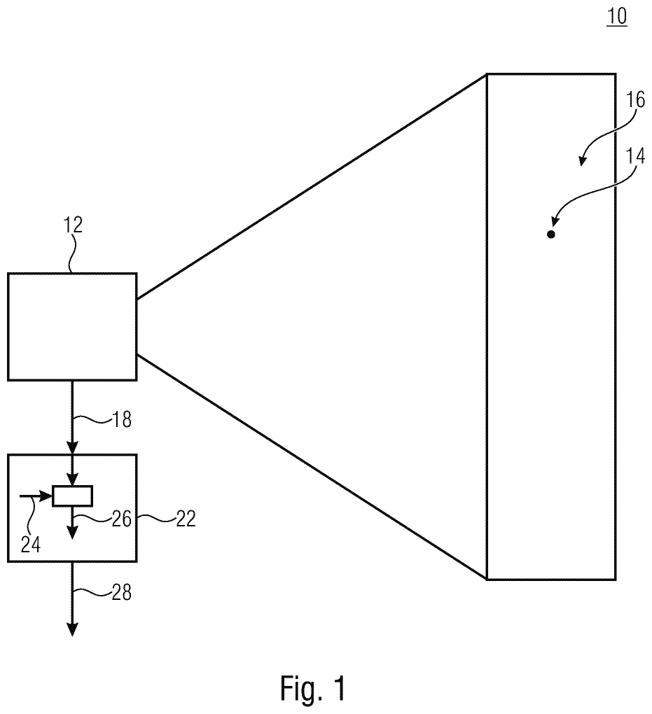

FIG. 1 shows a schematic block diagram of a device 10 for vibration analysis according to an embodiment. The device 10 comprises a capturing means 12 configured to capture a pattern 14 from a surface to be measured 16 to provide a captured image 18 of the pattern 14. To this end, the capturing means 12 may, for example, comprise an image sensor configured to capture at least part of the surface to be measured 16. The image sensor may be any image sensor by means of which the presence and/or displacement of an image on the sensor may be captured, for example a sensor of a line scan camera or a two-dimensional sensor such as a complementary metal oxide semiconductor (CMOS) image sensor.

Advantageously, a part of the surface to be measured 16 is captured by the capturing means 12, in which the pattern 14 is arranged during the entire measurement, so that a readjustment of the capturing means 12 during the measurement may be dispensed with. The surface to be measured may be any surface that is to be examined with respect to oscillation, displacement or vibration. Embodiments described herein are particularly suitable for rotating surfaces, so that, for example, the surface to be measured may be a surface of a ball bearing. However, without any restrictions in functionality, surfaces mounted in a translatory or fixed manner may also be measured.

For example, the captured image 18 is formed in such a way that the pattern 14 has a specific position within the captured image 18. For example, if pattern 14 is a single dot, the position of the pattern 14 within image 18 may be the spatial expansion of the dot on the image sensor. However, according to other embodiments, it is also possible that the pattern 16, captured from the surface to be measured, at the location of the image sensor is larger than the image sensor itself and that the image sensor only captures part of the pattern. In these embodiments, the location of the pattern on the image sensor refers to a position of a reference section of the pattern, for example a special bar or ring on the image sensor and/or within image 18.

The device 10 further comprises an evaluation means 22 configured to evaluate the captured image 18 in order to obtain, by comparing the captured image 18 with a reference image 24, an evaluation result 28 which has information regarding vibration of the surface to be measured 16. Since the evaluation result 26 is based on a comparison of the captured image 18 and the reference image 24, it may be sufficient to determine only the displacement of the pattern 14 between the reference image 24 and the captured image 18. Therefore, although an analysis of the exact location of pattern 14 in images 18 and 24 may be carried out, it is not necessary because the displacement of pattern 14 may be determined already by a direct comparison, for example by using a cross-correlation. This allows simple and yet precise determination of the displacement of the pattern 14 in the image which, with a constant relative position of the capturing means 12, provides indications of a displacement of the surface to be measured 14 with respect to the capturing means 12 and thus provides information regarding vibration of the surface to be measured 16.

The reference image 24 may be a previously provided and/or stored image that is obtained, for example, during calibration of the device 10 and/or is otherwise provided in knowledge of the pattern 14. It is advantageous that the reference image 24 be a previous image obtained by the capturing means 12, for example during a multitude of iterations. Thus, the capturing means 12 may continuously capture images while using a preceding image as a reference image 24 for a currently captured image 18. In particular, if the evaluation means is configured to carry out the comparison on the basis of a cross-correlation between the captured image 18 and the reference image 24, a respective iterative comparison may indicate a result about a displacement of the surface to be measured between two iterations. This means that the capturing means 12 may be arranged to capture a multitude of images of the pattern 14 in a multitude of iterations so as to provide a multitude of images. The captured image 18 may be, for the purpose of comparison, a subsequent second image of the multitude of images that is captured in a second iteration. The reference image 24 may be an image that is first in relation to said captured image 18, i.e. may be a previously captured image captured in a previous first iteration. This may be the immediately preceding iteration. Even if this is the advantageous implementation, a less recent iteration may also be used for comparison purposes. The evaluation means 22 may be configured to accordingly take into account a time interval and/or a number of intermediate iterations in the evaluation result 26.

The evaluation means 22 may be arranged to compare the first image with the second image in order to obtain first information about a displacement of the surface to be measured between the first image and the second image, and to compare the second image with a third image captured in a third iteration following the second iteration in order to obtain second information about the displacement of the surface to be measured 16 between the second image and the third image. The information 28 about the vibration of the surface to be measured 16 may comprise the first information on the displacement and the second information on the displacement, that is, by a sequence of evaluation results 26, a vibration progress of a vibration of the surface to be measured 16 may be represented in the information 28 about the vibration.

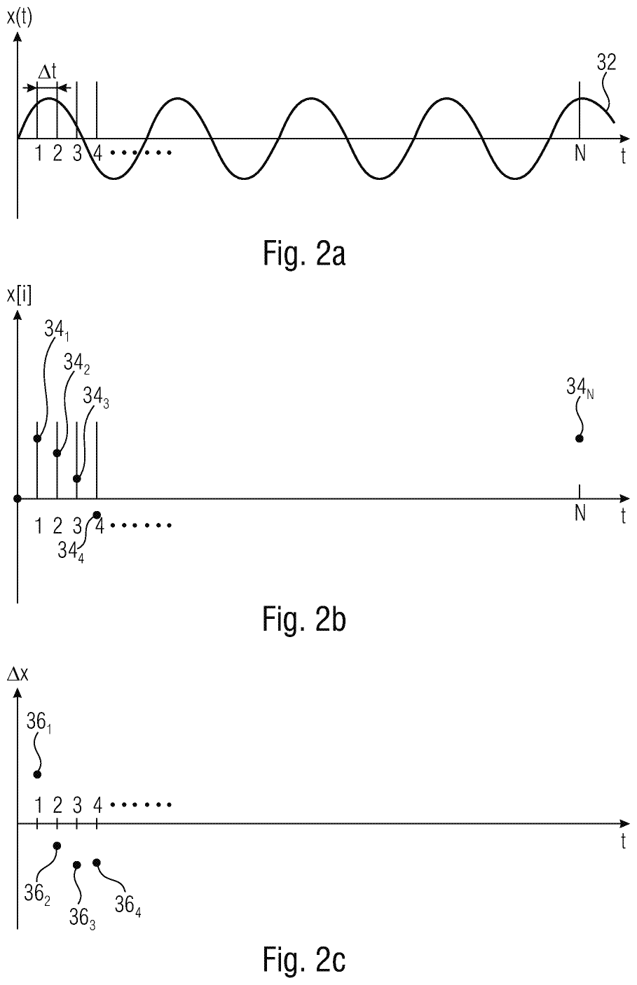

FIG. 2a shows a schematic graph for explaining the mode of operation of the evaluation means 22 according to an embodiment. An abscissa of the graph shows the time t, while an ordinate shows a path x as a function of the time t, which, for example, indicates a distance of the surface to be measured 16 with respect to a reference position. This means that the discrete values 34ᵢ indicate a position x[t] of the pattern 14 on the image sensor of the capturing means 12 at the time of capturing.

The reference position may be, for example, a location of the surface to be measured 16 in a vibration-free state. For example, a curve 32 indicates a position of pattern 14 on the image sensor. Said position may be transferred to the location of the surface to be measured via a geometrical relation/position between a location and/or orientation of the surface to be measured 16 and a location and/or orientation of the capturing means 12. This means that the capturing means 12 may be configured to determine a position of the surface to be measured 16 on the basis of the position of the pattern on the image sensor and/or on the basis of a displacement thereof.

The curve 32 thus shows, by way of example, a function of a change of location of the surface to be measured 16 over the time t, that is, the curve 32 describes, by way of example, vibration of the surface to be measured 16. The capturing means 12 is, for example, configured to provide, at certain times, i=1, . . . , N pictures taken of the surface to be measured 16, that is, to provide captured images 18. Between two successive pictures taken, a period of time Δt may be arranged, that is, a period of time of an iteration of the capturing process may be Δt. For example, the capturing means 12 may be arranged to provide at least 1,000 (1 kHz), at least 10,000 (10 kHz), at least 20,000 (20 kHz), at least 40,000 (40 kHz) or more, for example at least 50,000 (kHz) pictures taken per second, that is, the time Δt may be, for example, 1/1,000, 1/10,000, 1/20,000, 1/40,000 or 1/50,000 seconds. According to the Nyquist criterion, this enables analysis of vibrations up to frequencies of 500 Hz, 5 kHz, 10 kHz, 20 kHz, or 25 kHz. This means that the evaluation means may be configured to provide the evaluation result in such a way that it comprises information about vibrations which are carried out by the surface to be measured and have a frequency of at least 20 kHz.

FIG. 2b shows a schematic representation of a graph in which the analog curve 32 is converted into discrete values x[i] on the basis of the scanning with the capturing means 12.

FIG. 2c shows a schematic representation of a graph in which a comparison was made between respectively successive images, for example by evaluating a change in location x[i] of FIG. 2b to obtain a change in location Δx. This may be obtained, for example, by using a cross-correlation, which may be carried out by the evaluation means 22. Alternatively, however, other methods may be used to compare images. Points 36₁ to 36₄ can, for example, indicate a change in location x as compared to the previous iteration. The displacement Δx may be a part of the information 28 and thus indicate by how much the pattern on the image sensor of the capturing means 12 has changed between two images being viewed. By knowing the pick-up rate or the time Δt between two pictures taken and the geometrical relationship between the surface to be measured 16 and the capturing means 12, it is possible to deduce the distance covered by the surface to be measured 16. From this it also follows that it is advantageous, but not necessary, to use two consecutive pictures taken for the comparison, because if other pictures are used, only the time that has elapsed between the two recordings is variable and may be taken into account accordingly, even if this reduces the temporal resolution obtained.

The information thus obtained may also be transformed and/or converted. For example, information about a distance travelled may be transformed, on the basis of a temporal integration, into acceleration information and/or vice versa by means of a time derivative. Further transformations, for example into acceleration signals, may also be performed by the evaluation means. Such information may also be of interest for vibration analysis.

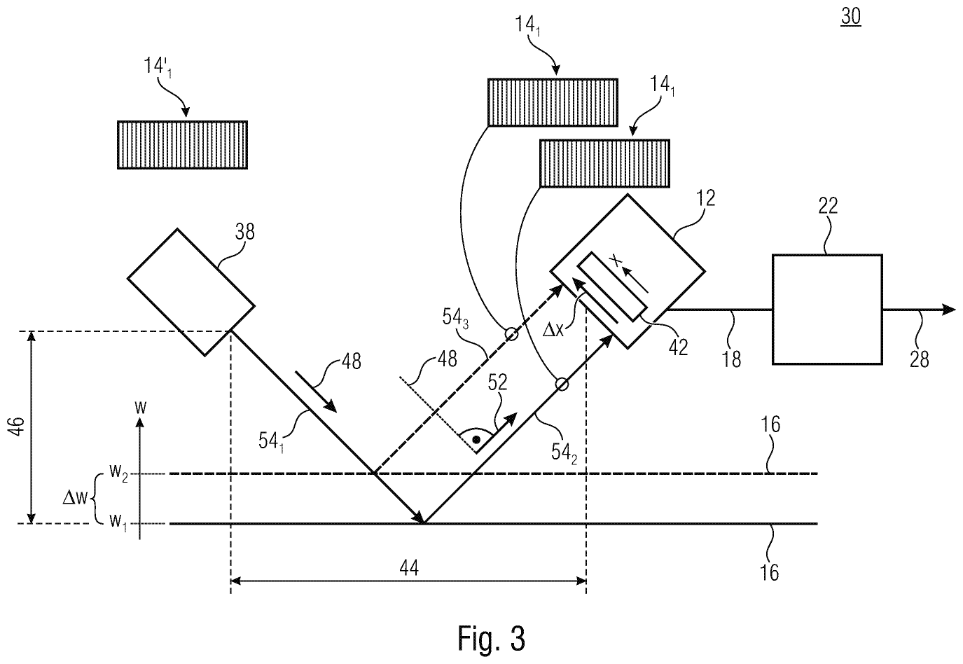

FIG. 3 shows a schematic block diagram of a device 30 for vibration measurement according to an embodiment. The device 30 may have an optical signal source 38 configured to emit the pattern in the direction of the surface to be measured 16. The surface to be measured 16 may be variably positioned along a direction w, for example on the basis of oscillation or vibration. The solid line indicates the location of the surface to be measured 16 along the direction w at a first point in time, while the dashed line indicates the location of the surface to be measured 16 at a second point in time, which follows the first point in time, for example.

Although the pattern 14 of FIG. 1 may also be used, the signal source 38 is configured, for example, to emit a bar pattern 14′₁ which is reflected or scattered at the surface to be measured 16, so that the reflected or scattered pattern 14₁ may be captured by the capturing means 12, for example by means of an image sensor 42 of the capturing means 12. The pattern 14₁ may thus be based on the emitted pattern 14′₁ and may be scattered, crushed or distorted by reflection or scattering or a surface property of the surface to be measured 16, and may thus correspond to the pattern 14′¹ that is reflected, scattered or otherwise changed by the surface to be measured 16. For the embodiments described herein, the pattern 14₁ may also be sent out directly, which may be understood to mean that only irrelevant distortions are obtained on the surface to be measured 16.

A path Δw travelled by the surface to be measured 16 between the two points in time or two locations w₁ and w₂ may lead to a displacement Δx of the pattern 14 on the image sensor 42 along a first image direction, for example the x direction. Knowing corresponding device dimensions, for example a distance 44 between the optical signal source 38 and the capturing means 12 and/or a distance 46 between the optical signal source 38 and the surface to be measured 16, somewhat in a vibration-free state, and/or other geometric parameters such as an angular orientation of the optical signal source 38 and/or of the capturing means 12 relative to one another and/or to the surface to be measured 16, or a distance between the capturing means 12 and the surface to be measured 16, the path displacement Δx may be converted into the path displacement Δw, which may provide an indication of the vibration or oscillation amplitude of the surface to be measured 16. According to an embodiment, an alignment between the optical signal source 38 and the capturing means 12 is selected such that a transmitting direction 48, along which the pattern 14 or 14′₁ is transmitted, and a receiving direction 52, from which the capturing means 12 is configured to receive the pattern 14₁, are arranged perpendicularly to each other within a tolerance range of ±15°, ±10° or ±5°, i.e. have an angle of 90° to each other.

As an alternative to using an optical signal source, the pattern 14 or 14₁ may also be arranged differently on the surface to be measured 16. for example by engraving, a printing process or by attaching a corresponding sticker, other or further processes also being conceivable. This makes it possible to obtain the pattern and to evaluate it even without any projection, the projection making it possible to measure different and variable high surfaces without first providing them with a corresponding pattern.

In other words, embodiments of the present invention make it possible to measure the structure-borne sound of a stationary or rotating part and/or of a vibrating machine by means of optical patterns. For this purpose, an image pattern 14′₁ is projected from a light source 38 onto the vibrating surface 16 via the corresponding beam (bundle of rays) 54₁ along the emitting direction 48 onto the vibrating surface 16. The reflected pattern 14₁ reaches the camera 12 along a beam 54₂ or 54₃ dependent on the location of the surface to be measured 16 and along the receiving direction 52, and may be captured there. If the reflecting surface 16 shifts from the position w₁ to the position w₂ as a result of vibrations, the pattern 14₁ within the camera 12 also shifts, which pattern in this case is transmitted along the beam or bundle of rays 54₃. The displacement of the pattern 14₁ between the points in time and in the camera image may be captured by means of signal processing.

The operating principle is based on evaluating the displacement of a known (defined) image pattern. Therefore, no monochromatic light is necessary, and no expensive optics are needed. The distance Δx between the patterns on the camera may be measured directly and, using known dimensions of the measurement setup, may be directly calculated back, with regard to the vibration path Δw or the speed as well as acceleration. The entire process is implemented in the time domain of a few kilohertz, so that no extremely fast technology as used for interferences or Doppler is necessary. According to this principle, the original problem of the extremely sensitive measurement of the transit time difference (interference method) or the extremely slow movement speed in comparison to light (Doppler method) is displaced into the area of length measurement (pixels or sub-pixels) where difference length measurement in the sub-micrometer range is no problem. From the point of view of signal analysis, this principle eliminates the extremely strong—but useless—direct component of the measurement signal (speed of light) by means of real formation of the differential.

The camera signal may be examined for the presence of two (or more) geometrically known patterns by using image and signal processing methods. The vibration path or the vibration speed of the surface to be measured results directly from the determined path difference on the camera chip, while the reflection angles are taken into account. The measuring principle refers to the fact that a light source 38 projects a given pattern. The emission beam 54₁ is directed onto the surface of the machine to be examined. w₁ and w₂ indicate different positions of the surface to be measured 16. The different positions lead to different locations of the reflection beams 54₂ and 54₃ from the respective position of the surface 16. The camera 12 receives the reflected predefined pattern for surface projection, so that different patterns from different positions are received via the beams 54₂ and 54₃.

In comparison to existing methods of optical or radiation-based vibration analysis, which try to extract dynamic changes (vibrations) from a static signal (speed of light) that is otherwise stronger by many orders of magnitude (10¹² . . . 10¹⁴), embodiments offer a solution with which the sought-after dynamic difference (pattern displacement) may be measured directly without the useless static component. A methodical novelty is that whereas up to now the dynamic signal component was searched for with an extremely high static component with a large amount of technological effort, the static component is omitted or not even captured at all according to embodiments. From a methodological point of view, this represents cantering of the measurement signal or the measurement image. From a technological point of view, this approach according to embodiments has considerable advantages compared to known concepts. A large number of components that may be used for implementing the embodiments are freely available and relatively inexpensive, so that such a system may be cheaper than, for example, laser vibrometers in terms of costs and the technological effort involved.

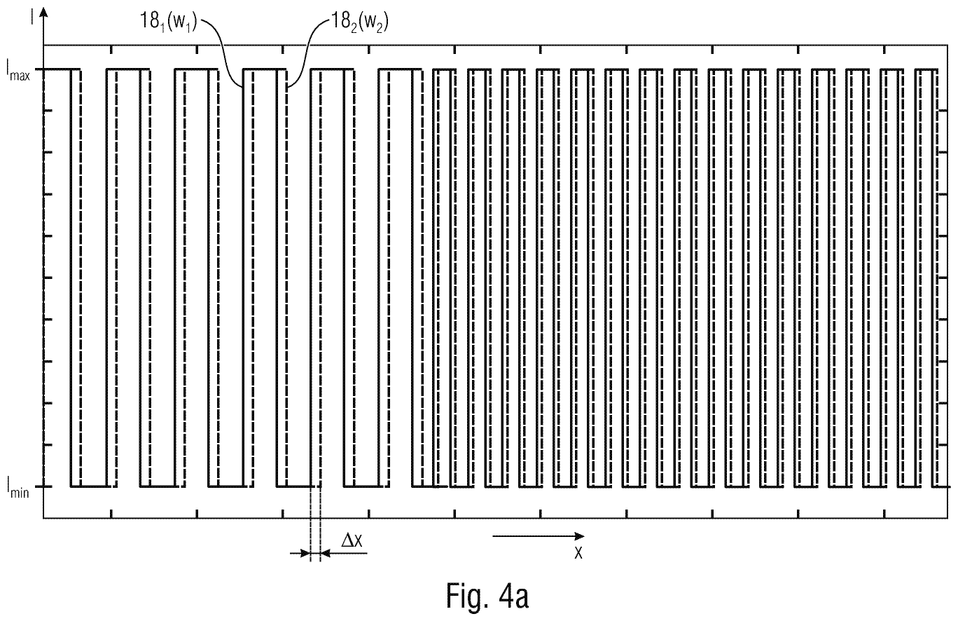

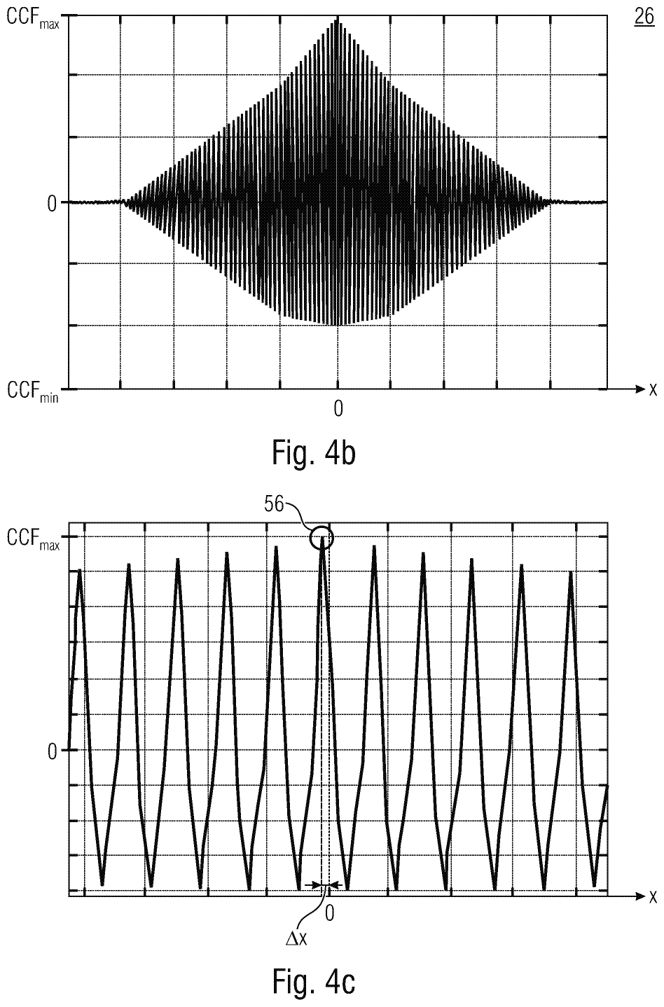

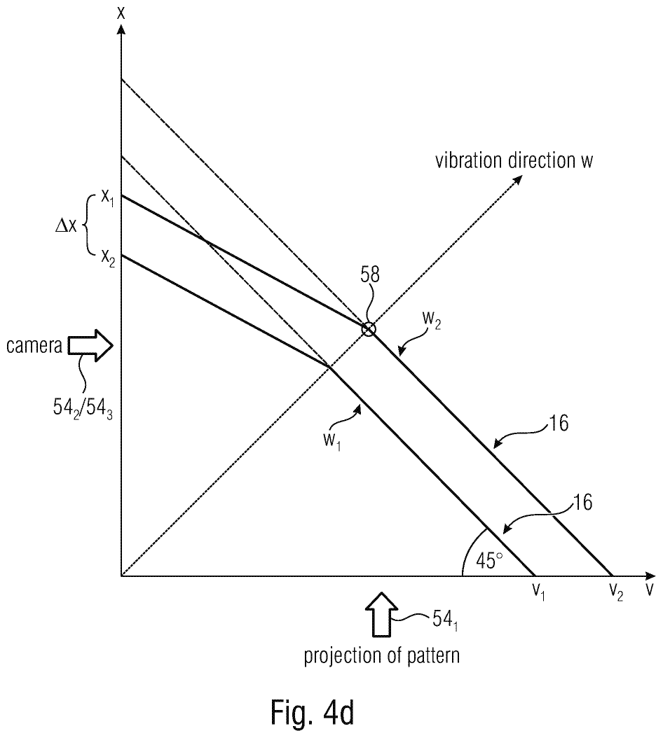

FIG. 4a shows a schematic representation of a comparison of two captured patterns on an image sensor, for example the image sensor 42 of FIG. 3. The image sensor may be a line scan camera, for example. The abscissa may represent the image direction x, while the ordinate represents an intensity of the respective image part or pixel. According to a binary bar pattern that changes between light and dark areas, the intensity I may change between a minimum value Iₘᵢₙ and a maximum value Iₘₐₓ and may be displayed on the image sensor in accordance with the bar pattern, which may be distorted by the reflecting surface 16. The solid line in FIG. 4a, for example, represents a first captured image 18₁ where the surface to be measured 16 is located at location w₁, so that the line is designated 18₁(w₁). For example, the dotted line 18₂(w₂) represents the captured image obtained when the patterns 14 surface to be measured 16 are located at the location w₂. The two images 18₁(w₁) and 18₂(w₂) are displaced on the image sensor by the distance ax.

In other words, FIG. 4a shows the distorted pattern, picked up by a line scan camera with a line sensor length of, for example, 25 mm. For example, level 0 (Iₘᵢₙ) corresponds to black and level 1 (Iₘₐₓ) corresponds to white. Because of the representation of the displacement (solid line for the first vibration position w₁, dashed line for the second vibration position w₂), only the contours of the pattern are shown.

FIG. 4b shows a schematic representation of an evaluation result 26 which may be obtained, for example, by using a cross-correlation of the two images 18₁(w₁) and 18₂(w₂) of FIG. 4a. That means, FIG. 4b shows a result of a cross-correlation function between two camera images when the surface to be measured 16 is vibrated.

FIG. 4c shows a schematic simplified representation of a central region of the graph in FIG. 4b. A global maximum 56 of the cross-correlation function of FIG. 4b is displaced by the value Δx in relation to the zero point. This value may be identified as the displacement of the pattern in the two curves of FIG. 4a.

FIG. 4d shows a schematic representation of a functional relationship between the vibration of the surface to be measured and a projection of the pattern and its capturing by the camera. A pattern is projected onto the possibly curved face of the surface to be measured, for example a simple striped pattern. The pattern received by the camera and displayed at the ordinate is distorted by the different positions of the surface to be measured, i.e. the different reflection surfaces, as shown in FIG. 4a. In FIG. 4d a situation is shown where the pattern projection and the camera plane are perpendicular to each other, which may be obtained by simple means. The main direction of the vibrating plane, i.e. the direction w, may lie on the bisector of the coordinates, i.e. both the optical signal source 38 and the capturing means 12 may each have a angle of 45° in relation to the vibrating surface. Here, a clear difference as compared to the laser triangulation method may also be seen: if the laser of a laser triangulation should aim at a location of a strong curvature, for example represented by a corner point 58 in the surface to be measured 16, which lies on the axis of the vibration direction w, the measurement results would be scattered or statistically unreliable as a result thereof. Such losses are avoided with the embodiments described herein.

In other words, and with renewed reference to FIGS. 4a to 4c, the embodiment according to FIGS. 4a to 4d has been simplified as far as possible to clearly present the principle. In this context, the following assumptions were made. According to FIG. 4d, the camera plane and the projection plane of the pattern (dot pattern, striped pattern, area pattern) are perpendicular to each other. Furthermore, the main movement of the vibrating surface 16 is located on the bisector between the planes of the pattern projection of the camera plane and is represented by the axis w, which corresponds to the vibration direction of the surface. Furthermore, the projection function. i.e. the surface function, is assumed to be known and may therefore be examined analytically. In this specific case, there are two linear dependencies which meet exactly on the bisecting line of the angle. Mathematical principles will be explained below:

Irrespectively of the projection pattern, the coordinates V are first projected into the camera plane x as a function of the vibration surface. In this specific case, the following projection equation applies:

x[0: V/2]=1.5×V_{1.2}−0.5V

x[V/2:V]=V_{1.2}−V

With the upper scaling operations, the indices were calculated within the camera plane. After this operation, the projection pattern, for example a line pattern, is projected onto the camera plane:

While FIG. 4a shows two camera patterns that are created after their projection onto a bent surface, it should be noted that in general, such reflected patterns may also be non-linear or irregular it may be considered within this context that the cross-correlation function (CCF) between two displaced camera patterns may detect the displacement of the vibrating surface independently of the curved surface, which is why it is used according to advantageous embodiments. For example, if a line scan camera is used, calculating the scalar product of the displaced projections as a function of the displacement may yield a result that directly indicates the displacement of the pattern on the image sensor between the two camera images considered. Since these projections may be captured in the acoustic sampling cycle (up to approx. 50 kHz), the temporal course of vibrations may be measured, which up to now has been difficult or even impossible to do with laser trigonometry.

FIG. 4b shows a complete cross-correlation function (CCF) of the displaced camera images of FIG. 4a. FIG. 4c shows a zoom in the central area of the CCF. The maximum of the CCF is at a displacement of Δx, for example −43 μm. If need be, this displacement may be converted to the actual vibration length www in FIG. 4d. For this purpose, projection equations may be used, as described above, for example. This means that the evaluation means may be configured to convert a displacement of the path of the pattern on the image sensor into a change in position or vibration of the surface to be measured while using projection equations describing the surface to be examined.

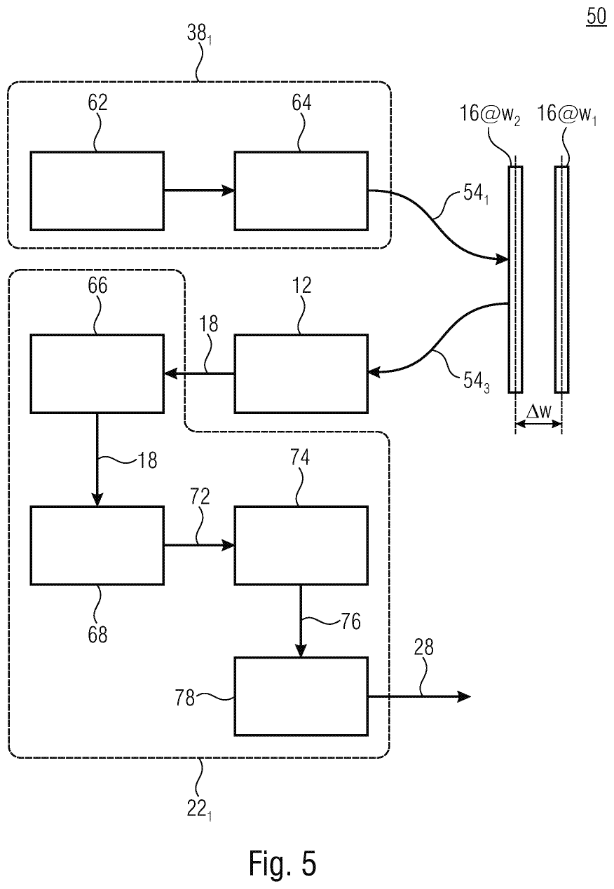

FIG. 5 shows a schematic block diagram of a device 50 for vibration analysis according to an embodiment. The device 50 comprises an optical signal source 381, for example the optical signal source 38 having a pattern generator 62 coupled to a pattern projector 64, the optical signal source 38, being configured to project a pattern onto the surface to be measured 16. The pattern generator may, for example, be an image generator providing an image to be projected to the pattern projector. Alternatively, the optical signal source may also be configured in such a way that a projector provides a possibly flat image, e.g. by pure illumination, and that the pattern generator receives the surface-directed illumination from the projector and subsequently inserts the pattern into the illumination signal, e.g. by an appropriate optical filter. This means that the sequence of generator 62 and projector 64 may also be interchanged. Alternatively, an optical signal source may be used in which the generator 62 and the projector 64 are combined in one function block.

The device 50 also includes the capturing means 12, for example in the form of a line scan camera or area scan camera. The capturing means is configured to provide images 18 sequentially and repeatedly in several iterations. The device 50 comprises an evaluation means 22₁, for example the evaluation means 22. The evaluation means 22₁ comprises an image memory 66 configured to store the multitude of images 18. The image memory 66 may alternatively be part of the capturing means 12 so that the evaluation means 22₁ may access the then external image memory 86 to obtain the images 18.

The evaluation means 22₁ comprises a correlator 68 configured to receive images 18 from the image memory 66 and to compare them with one another, the correlator 68 advantageously comparing two successive images 18 with one another by means of a cross-correlation function. The correlator 68 is configured to provide a correlation result 72, for example the evaluation result 26 shown in FIG. 4b. However, it is also possible to further process the evaluation result, or correlation result 72. For this purpose, the evaluation means 22₁ has a peak detector 74 configured to determine a local or advantageously global maximum value of the cross-correlation, i.e. In the correlation result 72, as described in connection with FIG. 4c. This means that the peak detector 74 may be configured to determine the maximum value 58. A result 76 of the peak detector 74 may thus contain information about the maximum value 56.

The evaluation means 22₁ may further comprise a signal processor 78 configured to determine, on the basis of the maximum value, a vibration distance, i.e. the distance Δw, which at least partially forms the information 28 with respect to the vibration. In particular, information about the vibration may be obtained from a plurality or multitude of information obtained about the vibration distance Δw.

Below, advantageous embodiments will be explained in connection with the pattern 14.

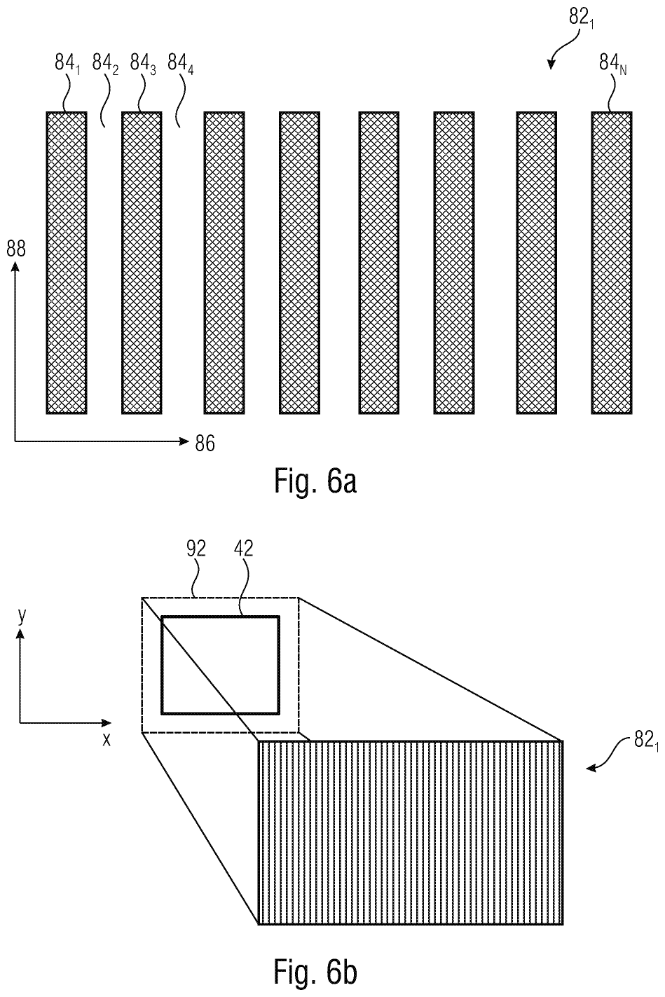

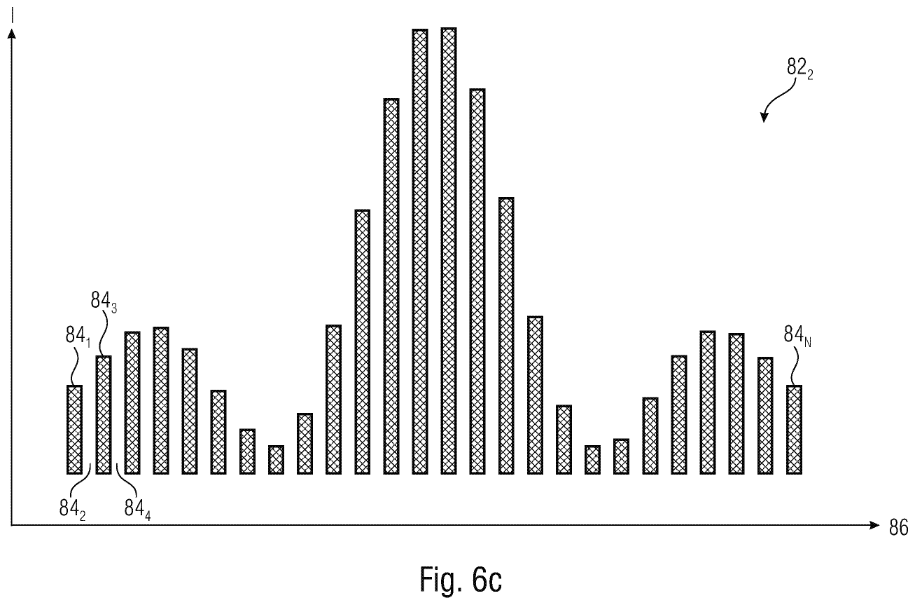

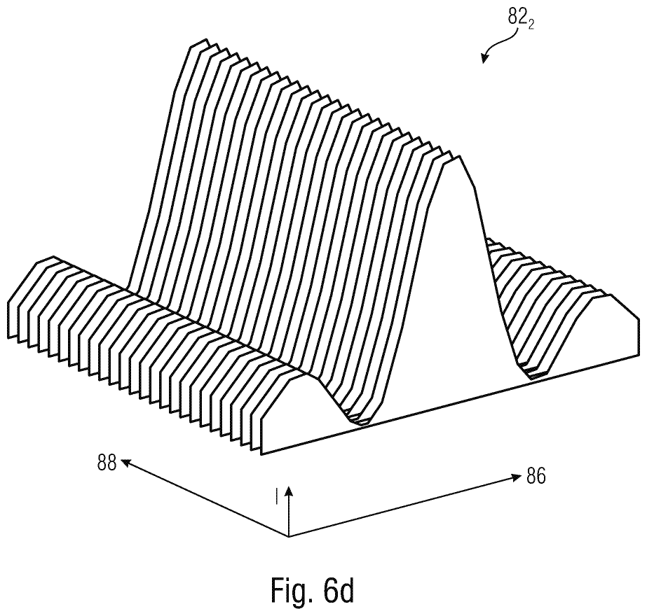

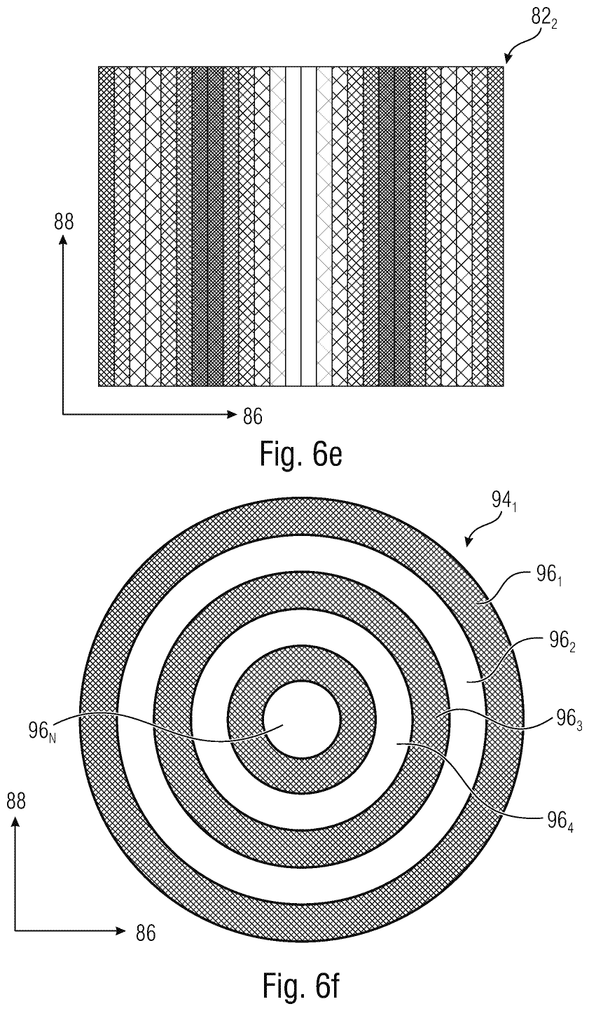

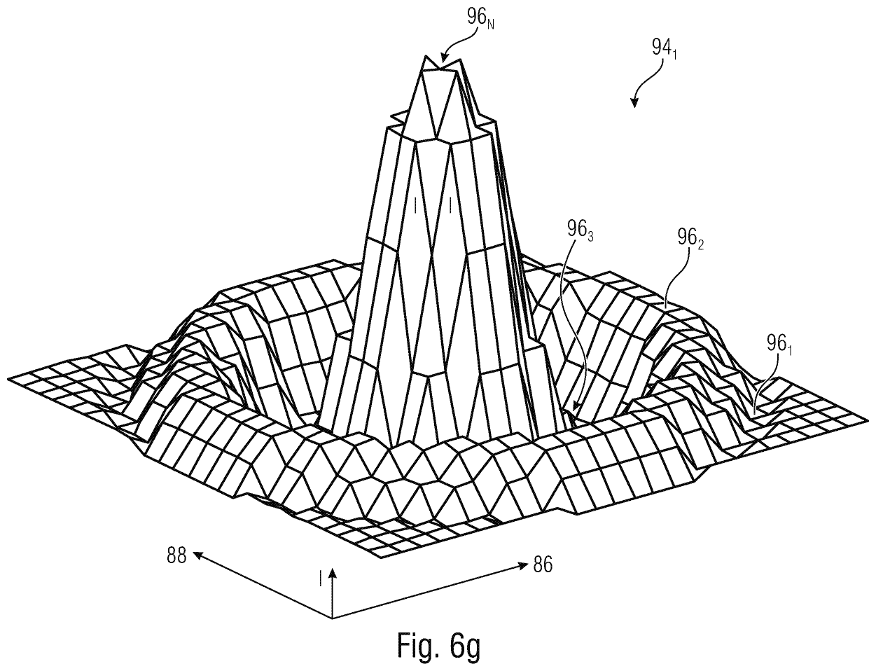

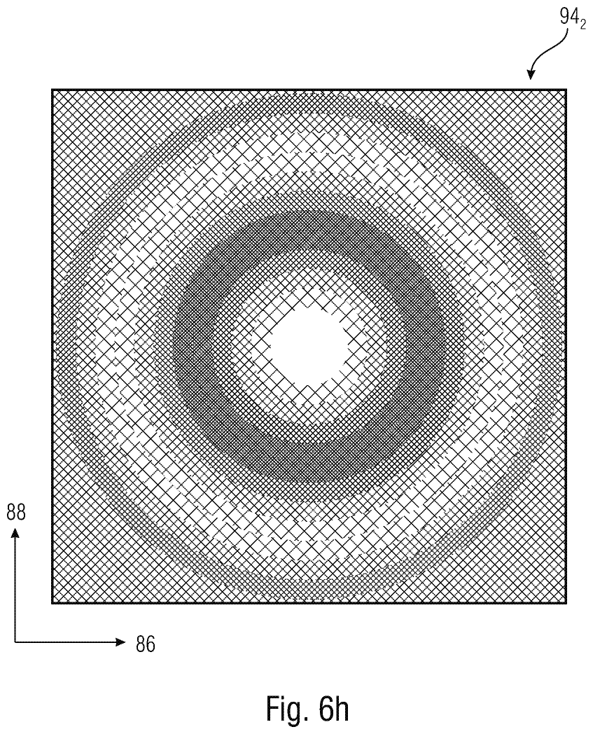

FIG. 6a shows a schematic view of a striped pattern 82₁, which is known as the pattern 14 or 14′ and has a wide range of stripes 84₁ to 84_{N}. Pattern 82₁ may be understood as an implementation of a two-dimensional pattern. The striped pattern 82₁ may, for example, be formed as a binary striped pattern in which alternating stripes of minimum intensity (logical 0), for example stripes 84₁ and/or 84₃, and stripes of maximum intensity (logical 1), for example bars 84₂ and/or 84₄, are arranged. The bars 84₁ to 84_{N} may have identical or different dimensions, among similar bars 84₁, 84₃ or 84₂ and 84₄, along two pattern directions 86 and 88 which are perpendicular to each other, wherein an identical dimension may also be selected for a simple implementation since a distortion of the pattern by the reflecting surface is to be expected. For example, a distortion of the striped pattern 82₁ may be used to obtain an image of FIG. 4a on the image sensor.

In other words, for the purpose of the simplest possible representation, the striped pattern 82₁ is an equidistant stretch of stripes. As a result, in practical measurements, periodicities may occur under certain circumstances after displacements, and therefore, uncontrolled ambiguities may occur, i.e. the striped pattern 82₁ is advantageously adapted in such a way that corresponding periodicities are avoided, e.g. by adapting the stripe width to the measuring range.

FIG. 8b shows a schematic perspective view of an image sensor 42 onto which the pattern 82₁ is reflected. According to an embodiment, the pattern 82₁ located within a plane 92 within which the image sensor 42 lies and is aligned in parallel therewith is configured in such a way that the pattern 82₁ has a size along a first sensor direction, approximately along the image direction x, and has an extension along a second sensor direction perpendicular thereto, approximately along a second image direction y, which is larger than that of the image sensor 42 along the corresponding direction, e.g., at least by a factor of 1.2, at least by a factor of 1.4, at least by a factor of 1.6 or any other value, for example also at least by a factor of 2, i.e. double the size, or extension. This means that the pattern 82₁ is projected, in parallel with the x direction, into the plane 92, for example is larger by the factor of at least 1.2, of at least 1.4, of at least 1.6, or of at least 2, and/or along the y direction. The increasing factor enables increasing certainty that the pattern will still hit the image sensor despite vibration of the surface to be measured. This makes it possible that despite vibration of the surface to be measured, a complete pattern is typically projected on the image sensor 42 and that detection of locations where the pattern is projected in particular may be dispensed with.

FIG. 6c shows a schematic representation of an intensity distribution of a striped pattern 82₂, in which individual stripes 84₁ to 84_{N} may have different intensities 1. This means that, compared to the striped pattern 81₁, instead of using only two intensity values to obtain a binary pattern, a plurality or multitude of intensity values may be used, that is, the bars having a value other than white may have a black value or a gray value; the gray value may have a multitude of individual levels. This allows an increase in precision of the vibration paths detected. In addition, the design of the pattern 82₂ to the effect that the multitude of bars may have a multitude of brightness intensities allows for robust position detection. By designing the stripes in such a way that at least the dark stripes within immediate vicinity are differently shaped, i.e. one dark stripe and a directly adjacent dark stripe, it is possible to avoid periodicity effects caused by strong vibrations. If, for example, the pattern 82 is considered, problems may arise if the pattern is displaced to such an extent that the displacement path covers at least the extension of a first light stripe and of a first dark stripe along the direction 86, since the individual stripes are not distinguishable from one another. According to the design of pattern 82₂, at least the directly adjacent dark stripes are distinguishable from one another on the basis of their grey values, so that an increased periodicity distance may be obtained.

According to a particularly advantageous embodiment, the brightness intensities of the bars 84, at least of the dark bars, are arranged within the two-dimensional pattern in accordance with a sinc function. The sinc function may be defined as sin(x)/x or sin(π)/πx.

FIG. 6d shows a schematic perspective view of the striped pattern 82₂ along the first pattern direction 88 and the second pattern direction 88, with a third dimension being represented by the intensities of the respective bars. Although FIG. 6d is shown in such a way that a multitude of individual sub-patterns are arranged along the second pattern direction 88, a continuous course of the individual bars may also be obtained along the pattern ring 88, as shown in FIG. 6a, for example.

In other words, the striped pattern may also be such that it may be clearly retrieved in order to avoid the periodicities with all conceivable displacements on the camera chip. For this purpose, the multitude of brightness intensities may be arranged within the two-dimensional pattern in an aperiodic order. For this purpose, the sinc function shown in FIGS. 6c and 6d, for example, may be suitable for signal analysis. From a point of view of signal analysis, the sinc function is particularly advantageous for subsequent signal processing since its Fourier transform ideally corresponds to a rectangular function, which is particularly suitable for fast and real-time analysis. This means that the evaluation means 22 or 22₁ may be configured, on the basis of the pattern design, to determine the pattern displacement in real time. A pattern as shown in FIG. 6c may be unambiguously identified regardless of its displacement on the chip, for example, of the line scan camera and along the line direction.

Single-line image capturing as shown in FIG. 6a may become a problem if the inspected surface is not completely flat or deforms in the course of the inspection. In such cases, a planar or spatial striped pattern is advantageous.

FIG. 6e shows a schematic top view of the striped pattern 82₂, in which the multitude of brightness intensities along the image direction 86 become clear. At the same time, it becomes clear that the striped pattern 82₂ may be formed to be constant along the second image direction 88.

In other words, single-line image capturing as shown in FIG. 6a may pose technical challenges if the inspected surface is not completely flat or deforms in the course of the inspection. In such cases, a planar or spatial striped pattern may be used, as shown in FIG. 6d, for example. The sketched striped pattern shown in FIG. 6d may be extended to form an area pattern or a spatial pattern. In principle, there are almost infinite possibilities for area expansion. In practice, different implementations may be used for this.

For example, a fan of striped patterns may be used as shown in FIG. 6d, which means that several striped patterns may be arranged along the image direction 88. This projection pattern may be suitable for applications where the line scan camera cannot be precisely aligned with the reflecting beams or where the direction of the beams is unstable, for example due to deformation of the surface. With this fan beam, the line scan camera may be reliably hit by the reflected beams even if there are mechanical uncertainties, such as vibrations in other dimensions, local curvatures and the like. Such a projection may be implemented with technical means that are available. For the sake of clarity, the envelopes of the striped patterns are shown below which the actual light stripes are located, see FIG. 6d, and their projection onto a flat surface, see FIG. 6e.

In addition, there is also the possibility of adapting the striped patterns to other implementations.

FIG. 6f shows a schematic top view of a ring pattern 94₁, which has a multitude of rings 96₁ to 96_{N} arranged concentrically to one another. The ring pattern 94₁ may be understood as bar pattern 82₁ which is adapted such that even a displacement of the pattern along the second pattern direction 88 may be detected. In particular, the image sensor of the capturing means may be configured as an area sensor, and/or an orientation of the pattern with respect to the image sensor may be dispensed with, even if the latter is designed as a line scan camera.

The rings 96 may be circular, but may also have a different shape, for example they may be elliptical and/or polygonal.

FIG. 6g shows a schematic perspective view of an intensity distribution of a ring pattern 94₂ along the pattern directions 86 and 88, in which the intensities of the individual rings 96₁ to 96_{N} are arranged according to the sinc function. Other inequalities may also be implemented; aperiodic arrangements of the intensities and especially the use of the sinc function are advantageous.

FIG. 6h shows a schematic top view of a projection of the ring pattern 94₂ onto a flat surface.

In other words, axisymmetric and/or rotationally symmetric striped patterns as shown in FIGS. 6g and 6h may also be used. In many cases, it may be assumed that the vibrating surface to be examined is spatially multimodal, i.e. the angle of reflection will radiate not only into the ideally desired plane of the line scan camera, but also into other spatial directions, and will therefore not be constant in time. For this case, rotationally symmetrical projection of the striped pattern of FIG. 6d, which is symmetrically projected in both dimensions, is well suited. In this way it may be achieved that neither the line scan camera nor the inspected area have to meet strict requirements. This option is a robust variant of the embodiments described herein. Here, too, the implementation effort remains very low, since compared to the implementations of FIGS. 6c to 6e, only an extension of the projection has to be implemented, which may be carried out without any problems.

In other words, FIG. 6g shows a spatial variant of the striped pattern of FIG. 6c. For the sake of clarity, the spatial envelope of the optical striped patterns is shown here. The stripes themselves are located under the envelope with the pattern of FIG. 6c.

The signal from the line scan camera may be evaluated with electronics connected thereto such as a microcontroller unit (MCU), a digital signal processor DSP or a field-programmable gate array (FPGA), for example, while using fast methods of signal and image processing. The goal is to calculate the current path difference between two positions of the vibrating surface in real time, i.e. at the rate of the acoustic sampling rate. In the case of the striped pattern, the camera image of the striped pattern may be evaluated. For this purpose, statistically reliable methods of correlation functions are suitable which, due to the high computing speed that may be employed in the frequency domain, may be performed by means of FFT (Fast Fourier Transformation). When using the projection pattern according to FIG. 6f, FIG. 6g or FIG. 6h, application of planar methods of image analysis (spatial correlation) or their functional equivalents within the frequency domain becomes feasible. A 2D FFT may be used for this purpose.

Compared with a dot pattern, the signal-to-noise ratio (SNR) may be improved—specifically, by the number of stripes—by the striped pattern and/or the ring pattern. The striped pattern and/or ring pattern may be used to examine the surface to be examined, for example a ball bearing, which may be curved and/or bent. If the curvature is sufficiently strong, the vibration occurring during laser triangulation would result in too low a light intensity in the detector, which would falsify the measurement result. By distributing a pattern over a possible curvature, the pattern will admittedly be distorted, but the vibration will change the pattern to a negligible extent only. The behavior may be explained by the cross-correlation function: a curvature will distort the pattern, but the distortion will remain during the vibration. Thus, it is then only useful to determine the displacement of the distorted pattern that is caused by the vibration, which is possible by using the cross-correlation function.

Compared to triangulation, embodiments described herein may have a different objective: in triangulation, one determines the distance of a point from one or two light detectors. This may of course also be realized for moving objects, such as moving surfaces. On the other hand, the goal of embodiments is not to measure the distances but to capture the temporal course of the relative surface position, which may be done faster, by orders of magnitude, than in triangulation. There, an attempt is made to obtain the signal from a conventional vibration sensor (path, speed, acceleration) by optical means. For this purpose, one light spot is not sufficient since a single light spot may be randomly located at a position unfavorable for vibration measurement (vibration node, mechanically damped location, mechanical edge).

The representation of the striped pattern in connection with the devices 10, 20 and 50 described herein corresponds, in terms of quality, to one possible implementation of the embodiments described herein. If the reflected patterns are larger than the capturing range of the camera, as described in connection with FIG. 6b, one may be relatively sure that the camera will capture the patterns even without the otherwise complex calibration, or alignment. In terms of resolution, it is also advantageous to use larger pattern elements because the larger a pattern element appears on the camera chip, the more sensitively the displacement may be determined, so that as a result, the time course of the displacement that is of interest is measured exactly. If, for example, a line scan camera with a length of 20 mm (capturing range or extension of the image sensor) is assumed, the projection pattern may be at least twice as long, i.e. at least 40 mm. It may then be assumed with relative certainty that the pattern deformed by the surface still completely covers the line scan camera. In principle, it is possible without any adverse effects if the line scan camera is not completely covered by the reflected pattern, but a decrease in the signal-to-noise ratio (SNR) may then occur. The appropriate width of the stripes may depend on several parameters: a curvature of the examined surface, the pattern structure (simple stripes, sin function, other structured patterns, etc.). It may be the that the dearer the pattern structure is (e.g. as a sin function), the finer the stripes may be (the smaller their widths), and the more accurate the determination of the vibration may be.

In other words, referring again to FIG. 5, this shows a block diagram and signal processing according to an embodiment. If possible, a flat pattern, in the simplest case a striped pattern, may be generated in the pattern generator 62, as shown in FIG. 6a, for example. The pattern may have larger dimensions than the camera chip, for example by a factor of 1.2, 1.3, 1.4 or more, if the projection of the pattern into the plane of the camera chip is viewed, in order to typically fully cover the capturing range of the camera under normal operating conditions. To avoid ambiguity, the pattern may be implemented according to the explanations given in connection with FIG. 6c, 6d, 6e, 6g or 6h. Due to the directional dependence, the pattern shown in FIGS. 6g and 6h may be considered to be ideal. The pattern is optically projected, by means of the pattern projector 64, onto the vibrating surface to be examined 16. Due to the time-varying distance of the vibration surface, the reflected pattern is captured by the camera 12. Due to the vibration-induced displacement of the pattern, which is possibly also distorted, the camera 12 receives projections displaced on the camera chip. In order to evaluate the displacement, at least two consecutive images 18 may be stored in the image memory 66. The images stored in the image memory 66 are cross-correlated with one another, e.g., within the correlator 68 across the entire pixel range of the camera. Since the real path displacement Δw is found in the maximum of the CCF, the correlator is followed by a peak detector 74 which detects the current path displacement on the basis of the CCF maximum. The current detected displacement may be evaluated in the analog-to-digital signal processor (ADSP)/evaluation 78 to yield result signals and parameters which are important for vibration technology. The evaluation means may be configured to provide the provided information regarding the vibration of the surface to be measured in such a way that the information 28 comprises an indication of a power spectrum of the vibration of the surface to be measured and/or of an order spectrum of the vibration of the surface to be measured and/or of a change in a spectrum over time and/or of a change in location of the spectrum and/or of an extrapolation of a vibration value and/or of a comparison result of the vibration or of a value derived therefrom with a threshold value, e.g. to check whether a spectrum or a trend has exceeded or reached a threshold value, the threshold value being, for example, a defined vibration threshold that may indicate imminent damage, or damage that has already occurred, to a device that has the surface to be measured.

The above-described embodiments describe devices in which the evaluation means is configured to obtain the evaluation result by comparing a captured image with a reference image. Alternatively or additionally, the device 10 of FIG. 1 may also be described in such a way that the capturing means is configured to capture a two-dimensional pattern, for example one of the patterns of FIGS. 6a to 6h, from a surface to be measured in order to provide a captured image of the two-dimensional pattern. This may be a reflected or scattered projection of the pattern on the surface to be examined; alternatively or additionally, the pattern may be fixedly arranged on the surface. The evaluation means 22 may be configured to evaluate the image of the two-dimensional pattern in order to obtain an evaluation result which contains information regarding vibration of the surface to be measured. Under certain circumstances, comparison with a reference image may be dispensed with here; for example, parameters extracted from the image may also be evaluated, for example a size of the pattern, of components thereof and/or orientations of the pattern or components thereof on the image sensor. These evaluated parameters may also be converted to a distance if the basic geometric conditions are known in advance. According to one embodiment, however, the evaluation means may also be configured to obtain, by comparing the captured image with a reference image, the evaluation result which contains the information regarding the vibration of the surface to be measured 16.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer. A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU) or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fail within the true spirit and scope of the present invention.

1. Device for vibration analysis, comprising:
a capturer comprising an image sensor and configured to capture a pattern from a surface to be measured to provide a captured image of the pattern;
an evaluator configured to evaluate the captured image in order to acquire, by comparing the captured image with a reference image, information on a displacement of the surface to be measured between the image captured and the reference image, and to acquire an evaluation result comprising information regarding vibration of the surface to be measured;
wherein the pattern is a two-dimensional pattern comprising a multitude of stripes or concentric rings arranged side by side, the multitude of stripes or rings comprising a multitude of brightness intensities;
wherein the multitude of brightness intensities are arranged within the two-dimensional pattern in an aperiodic order; or
wherein the multitude of brightness intensities are arranged within the two-dimensional pattern in accordance with a sinc function.

2. Device as claimed in claim 1, wherein the evaluator is configured to carry out the comparison on the basis of a cross-correlation between the captured image and the reference image.

3. Device as claimed in claim 1, wherein the capturer is configured to capture a multitude of images of the pattern in a multitude of iterations and to provide a multitude of images;
wherein the image is a second image of the multitude of images that is captured in a second iteration, wherein the reference image is a first image of the multitude of images that is captured in a preceding first iteration;
wherein the evaluator is configured to compare the first image with the second image to acquire first information on a displacement of the surface to be measured between the first image and the second image, and to compare the second image with a third image captured in a third iteration following the second iteration to acquire second information on the displacement of the surface to be measured between the second image and the third image, the information on the vibration comprising the first information on the displacement and the second information on the displacement.

4. Device as claimed in claim 1, wherein the evaluator comprises a correlator configured to perform cross-correlation while using the image and the reference image and to provide a correlation result, the evaluator further comprising a peak detector configured to determine a maximum value of the cross-correlation, the evaluator further comprising a signal processor configured to determine, on the basis of the maximum value, a vibration distance which at least partially constitutes the information regarding the vibration.

5. Device as claimed in claim 1, wherein the capturer comprises an image sensor, the evaluator being configured to provide the evaluation result on the basis of an evaluation of a displacement of the pattern on the image sensor.

6. Device as claimed in claim 5, wherein due to projection along a first sensor direction and along a second sensor direction, the pattern exhibiting an extension, within a plane of the image sensor, that is larger than that of the image sensor.

7. Device as claimed in claim 1, which is configured to measure the surface to be measured in a curved region thereof.

8. Device as claimed in claim 1, further comprising:
an optical signal source configured to emit the pattern towards the surface to be measured.

9. Device as claimed in claim 8, wherein a transmitting direction along which the optical signal source is configured to transmit the pattern, and a receiving direction from which the capturer is configured to receive the pattern are arranged perpendicularly to each other within a tolerance range of ±15°.

10. Device as claimed in claim 1, wherein the capturer is configured to capture a multitude of images of the pattern with a frequency of at least 40 kHz, the evaluator being configured to provide the evaluation result from the multitude of images in accordance with the Nyquist criterion so that it comprises information on oscillations comprising a frequency of at least 20 kHz.

11. Device as claimed in claim 1, wherein the evaluator is configured to provide the information regarding the vibration of the surface to be measured in such a way that the information comprises an indication of a power spectrum of the vibration of the surface to be measured and/or of an order spectrum of the vibration of the surface to be measured and/or of a change in a spectrum over time and/or of a change in location of the spectrum and/or of an extrapolation of a vibration value and/or of a comparison result of the vibration or of a value derived therefrom with a threshold value.

12. Vibration analysis method, comprising:
capturing a pattern from a surface to be measured;
providing a captured image of the pattern;
evaluating the captured image and acquiring an evaluation result by comparing the captured image with a reference image so that the evaluation result comprises information regarding vibration of the surface to be measured;
so that the pattern is a two-dimensional pattern comprising a multitude of stripes or concentric rings arranged side by side, and the multitude of stripes or rings comprise a multitude of brightness intensities;
so that the multitude of brightness intensities are arranged within the two-dimensional pattern in an aperiodic order; or
so that the multitude of brightness intensities are arranged within the two-dimensional pattern in accordance with a sine function.

13. A non-transitory digital storage medium having a computer program stored thereon to perform the vibration analysis method, said method comprising:
capturing a pattern from a surface to be measured;
providing a captured image of the pattern;
evaluating the captured image and acquiring an evaluation result by comparing the captured image with a reference image so that the evaluation result comprises information regarding vibration of the surface to be measured;
so that the pattern is a two-dimensional pattern comprising a multitude of stripes or concentric rings arranged side by side, and the multitude of stripes or rings comprise a multitude of brightness intensities;
so that the multitude of brightness intensities are arranged within the two-dimensional pattern in an aperiodic order; or
so that the multitude of brightness intensities are arranged within the two-dimensional pattern in accordance with a sinc function,
when said computer program is run by a computer.
